(19) United States
(12) Patent Application Publication
(10) Pub. No.: US 2015/0110267 A1
(43) Pub. Date: Apr. 23, 2015

(54) Unified Key Schedule Engine

(71) Applicant: ADVANCED MICRO DEVICES, INC., Sunnyvale, CA (US)

(72) Inventor: Winthrop J. Wu, Shrewsbury, MA (US)

(73) Assignee: ADVANCED MICRO DEVICES, INC., Sunnyvale, CA (US)

(21) Appl. No.: 14/058,007

(22) Filed: Oct. 18, 2013

(51) Int. Cl. H04L 9/08

(52) U.S. Cl. CPC H04L 9/0861; H04L 2209/24
USPC 380/44

(57) ABSTRACT

A key generator may comprise a first set of word registers each configured to store at least one word of a prior key, a set of computational elements coupled with the first set of word registers, one or more path selection elements coupled with the set of computational elements, wherein the one or more path selection elements are configured to select as a selected computational pathway a first computational pathway including a first subset of computational elements when a mode selection signal indicates a first mode, and select as the selected computational pathway a second computational pathway including a second subset of computational elements when the mode selection signal indicates a second mode, and a second set of word registers coupled with the set of computational elements, wherein each of the second set of word registers is configured to store at least one word of a new key generated by the selected computational pathway.

### TECHNICAL FIELD

This disclosure relates to the field of encryption and, in particular, to a key generator for generating a key schedule.

### BACKGROUND

In addition to a central processing unit (CPU), a computer system may in some cases utilize a coprocessor for performing additional functions. For example, a coprocessor may be used to perform such operations as floating point arithmetic, graphics operations, signal processing, string processing, encryption, compression, and interfacing with peripheral devices. Coprocessors may thus be optimized for performing specific types of calculations efficiently, and may increase overall system performance by offloading processor-intensive tasks from the CPU.

A coprocessor may be used to perform a series of cryptographic operations, such as encryption or decryption of data according to an Advanced Encryption Standard (AES) process, for example, which may operate on cipher sizes of 128, 192, or 256 bits. The AES process may perform a series of repeated operations on the input data, with each iteration utilizing a round key from a key schedule and the results of the previous iteration. The keys in the key schedule may be generated according to a key expansion process that generates keys having 128, 192, or 256 bits, depending on the AES cipher.

### BRIEF DESCRIPTION OF THE DRAWINGS

The present disclosure is illustrated by way of example, and not by way of limitation, in the figures of the accompanying drawings.

FIG. 1 illustrates an embodiment of a computer system.

FIG. 2 illustrates a cryptographic engine and key generator, according to an embodiment.

FIG. 3 illustrates pseudocode for a key expansion process, according to an embodiment.

FIG. 4 illustrates an embodiment of a key generator.

FIG. 5 illustrates a computational pathway for implementing an AES-128 key expansion process in a key generator, according to an embodiment.

FIG. 6 illustrates a computational pathway for implementing an AES-192 key expansion process in a key generator, according to an embodiment.

FIG. 7 illustrates a computational pathway for implementing an AES-256 key expansion process in a key generator, according to an embodiment.

FIG. 8 is a flow diagram illustrating an embodiment of a key generation process.

### DETAILED DESCRIPTION

The following description sets forth numerous specific details such as examples of specific systems, components, methods, and so forth, in order to provide a good understanding of the embodiments. It will be apparent to one skilled in the art, however, that at least some embodiments may be practiced without these specific details. In other instances, well-known components or methods are not described in detail or are presented in a simple block diagram format in order to avoid unnecessarily obscuring the embodiments. Thus, the specific details set forth are merely exemplary. Particular implementations may vary from these exemplary details and still be contemplated to be within the spirit and scope of the embodiments.

One embodiment of a unified key generator architecture for a cryptographic engine may be capable of generating different sized keys; for example, a key generator according to an embodiment may be capable of generating key schedules for use with any of the AES-128, AES-192, and AES-256 ciphers. In one embodiment, the key generator may generate at least one new key of the key schedule for each clock cycle. For example, one embodiment of the key generator may generate two or more AES-128 keys per clock cycle. The same key generator may also be capable of generating at least one new AES-192 or AES-256 key per clock cycle. In one embodiment, at least some of the words of the new key or keys may be generated in parallel with each other.

In one embodiment, a key generator architecture capable of generating key schedules for use with the different AES ciphers may include a set of computational elements, each of which is capable of performing one or more cryptographic operations that make up part of the key expansion process. The key generator architecture may also include path selection elements, such as multiplexers or switches, which can be used to select computational pathways along which signals are routed to different computational elements so that different types of keys can be generated. For example, the path selection elements of the key generator may respond to a mode selection signal to select the appropriate computational pathways to generate AES-128, AES-192, or AES-256 key schedules, depending on a mode indicated by the mode selection signal.

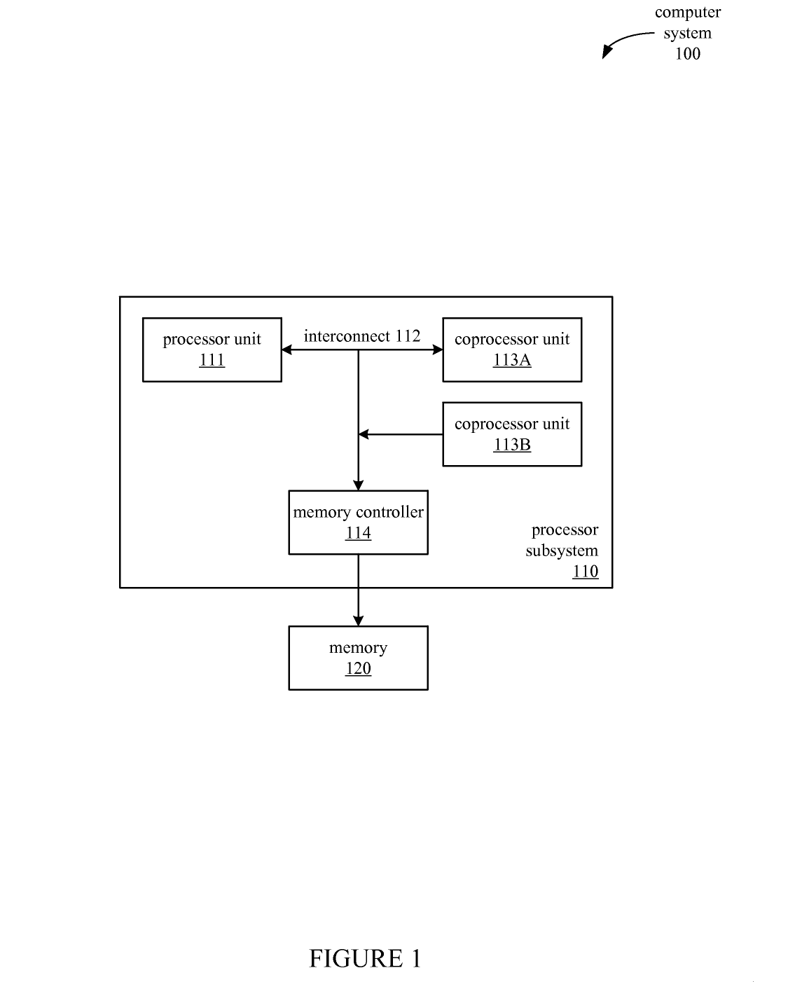

FIG. 1 illustrates an embodiment of a computer system 100 including a coprocessor which may implement a computational engine supported by a key generator, as described above. Computer system 100 may include a processor subsystem 110 coupled with memory 120. Computer system 100 may be any of various types of devices, including, but not limited to, a personal computer system, desktop computer, laptop or notebook computer, mainframe computer system, handheld computer, workstation, network computer, a consumer device such as a mobile phone, pager, or personal data assistant (PDA). Computer system 100 may also be any type of networked peripheral device such as storage devices, switches, modems, routers, etc. Although a single computer system 100 is shown in FIG. 1 for convenience, system 100 may also be implemented as two or more computer systems operating together.

In one embodiment, processor subsystem 110 may include one or more processors or processing units. For example, processor subsystem 110 may include one or more processor units, such as processor unit 111, that are coupled to one or more coprocessor units (e.g., coprocessor units 113A and 113B). In various embodiments, processor subsystem 110 (or each processor unit within 110) may contain a cache or other form of on-board memory.

Memory 120 is coupled with processor subsystem 110 and is usable by processor subsystem 110. Memory 120 may be implemented using different physical memory media, such as hard disk storage, floppy disk storage, removable disk storage, flash memory, random access memory (RAM-SRAM, EDO RAM, SDRAM, DDR SDRAM, etc.), read-only memory (PROM, EEPROM, etc.), and so on. In one embodiment, the available memory in computer system 100 is not limited to memory 120. Rather, computer system 100 may be said to have a “memory subsystem” that includes various types/locations of memory. For example, the memory subsystem of computer system 100 may, in one embodiment, include memory 120, cache memory in processor subsystem 110, and storage on various I/O devices (e.g., a hard drive, storage array, etc.). Thus, the phrase “memory subsystem” may represent various types of possible memory media that can be accessed by computer system 100. In some embodiments, the memory subsystem stores program instructions executable by processor subsystem 110.

Processor subsystem 110 includes a processor unit 111, coprocessor units 113A and 113B, and a memory controller 114, all coupled together via an interconnect 112 (e.g., a point-to-point or shared bus circuit). In one embodiment, processor unit 111 and coprocessor units 113A and 113B may be located on the same die. In an alternative embodiment, processor unit 111 and coprocessor units 113A and 113B may be located on separate dies. In one embodiment, coprocessor unit 113B and memory controller 114 may be omitted from the processor subsystem 110. For example, processor unit 111 may be coupled only to a single coprocessor unit (e.g., 113A); alternatively, processor unit 111 may be coupled to multiple coprocessor units (e.g., 113A and 113B). Additional coprocessor units may be possible in other embodiments. In various embodiments, processor unit 111 and coprocessor units 113A and 113B may share a common memory controller 114. Memory controller 114 may be configured, for example, to access a main system memory (e.g., memory 120). In other embodiments, each processor unit 111 and coprocessor units 113A and 113B may be coupled to respective memory controllers.

In one embodiment, processor unit 111 is a general-purpose processor unit (e.g., a central processing unit (CPU)) that may include one or more execution units. Alternatively, unit 111 may be a special-purpose processor such as a graphics processor. In one embodiment, processor unit 111 may be configured to execute instructions fetched from memory 120 using memory controller 114. The architecture of unit 111 may have various features; for example, it may be pipelined. In other embodiments, processor unit 111 may implement a multithreaded architecture for simultaneously executing multiple threads. Processor unit 111 may execute, without limitation, application-specific instructions as well as operating system instructions. These instructions may allow the implementation of any number of features, including, as just one example, virtual memory.

In one embodiment, processor unit 111 maybe coupled as a companion processor to one or more coprocessor units 113A and 113B, permitting unit 111 to provide instructions to coprocessor units 113A and 113B. Instructions provided by processor unit 111 to coprocessor units 113A and 113B may be within a common instruction stream (i.e., unit 111 fetches instructions to execute and provides certain of those fetched instructions to unit 113A and 113B for execution). Certain instructions provided from processor unit 111 to coprocessor unit(s) 113A and 113B may be “control” instructions generated by a functional unit within processor unit 111 to control the operation of coprocessor unit(s) 113A and 113B.

In one embodiment, coprocessor units 113A and 113B may be used to help perform the work of processor unit 111. As with processor unit 111, coprocessor units 113A and 113B are not limited to any particular function or architecture. In various embodiments, coprocessor units 113A and 113B may be general-purpose or special-purpose processors (e.g, graphics processor units (GPU), video decoding processors, encryption processors, queue managers, etc.). In one embodiment, coprocessor units 113A and 113B may be implemented as a field-programmable gate array (FPGA). In some embodiments, coprocessor units 113A and 113B may be pipelined. Coprocessor units 113A and 113B may, in some embodiments, employ a multithreaded architecture. In various embodiments, coprocessor units 113A and 113B may be configured to execute microcode instructions in order to perform certain instructions received from unit 111. In certain embodiments, coprocessor units 113A and 113B may support the use of virtual memory.

In one embodiment, interconnect 112 may be a shared bus circuit that couples processor unit 111 to coprocessor units 113A and 113B. In one embodiment, interconnect 112 may implement a “virtual tunnel” that allows processor unit 111 to communicate with coprocessor units 113A and 113B via a packet-based protocol such as Hyper Transport or PCI-Express. In some embodiments, interconnect 112 may be a front-side bus. In one embodiment, coprocessor units 113A and 113B may be coupled to processor unit 111 through a Northbridge-type device.

In one embodiment, memory controller 114 is configured to provide an interface for processor unit 111 and/or coprocessor units 113A and 113B to access memory (e.g., memory 120). Memory controller 114 may be used, for example, to fetch instructions or to load and store data. In one embodiment, processor unit 111 may use memory controller 114 to fetch instructions for execution in processor unit 111 or coprocessor units 113A and 113B. In another embodiment, a coprocessor unit 113A or 113B may use memory controller 114 to fetch its own instructions or data.

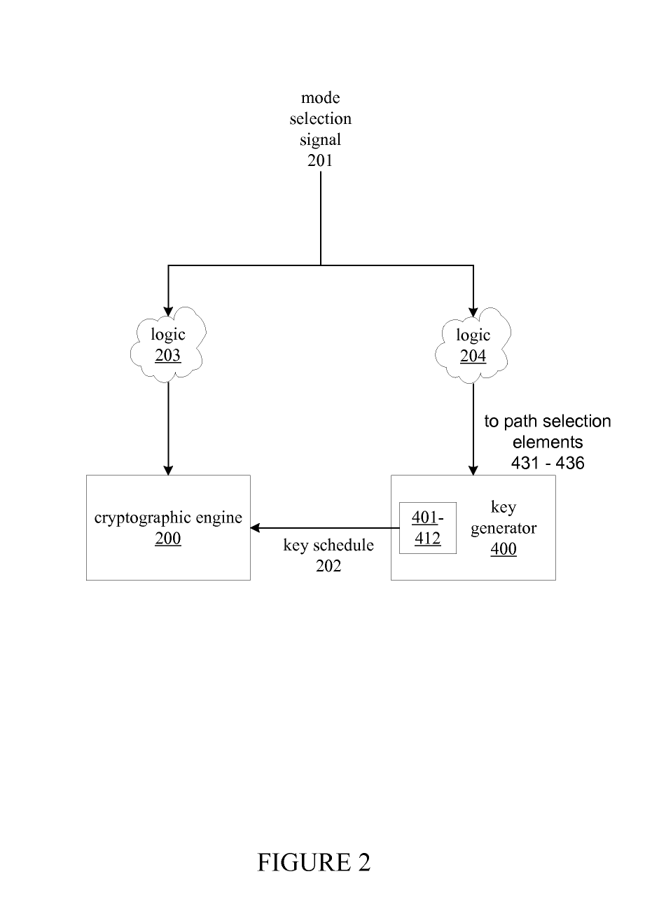

FIG. 2 illustrates a cryptographic engine 200 that may be implemented in a coprocessor unit such as coprocessor units 113A or 113B. In one embodiment, the cryptographic engine 200 may be an Advanced Encryption Standard (AES) cryptographic engine that is capable of encrypting plaintext data to produce encrypted ciphertext, or to decrypt ciphertext into the original unencrypted plaintext. In one embodiment, the cryptographic engine 200 may perform these encryption and decryption processes using a key schedule 202 that is generated by a key generator 400.

In one embodiment, the cryptographic engine 200 may support encryption and decryption according to multiple modes of operation. In one embodiment, the mode of operation of the cryptographic engine 200 may be selected based on a mode selection signal 201. For example, the cryptographic engine 200 may switch to executing the cryptographic operations associated with a first mode when the mode selection signal 201 indicates the first mode, and may switch to executing the cryptographic operations associated with a second mode when the mode selection signal 201 indicates the second mode. In one embodiment, the mode selection signal 201 may be capable of indicating more than two different modes, and the cryptographic engine may accordingly be capable of operating in more than two different modes.

For example, an AES cryptographic engine 200 may be capable of encrypting or decrypting input data using a different mode for each of the AES-128, AES-192, and AES-256 ciphers. In one embodiment, the cryptographic engine may generate output data by executing a different set of cryptographic operations on the input data while operating in each of these different modes. Thus, the cryptographic engine may be configured to generate the output data by executing an AES-128 cryptographic process when the mode selection signal indicates the first mode, an AES-192 cryptographic process when the mode selection signal indicates the second mode, and an AES-256 cryptographic process when the mode selection signal 201 indicates a third mode. In one embodiment, some of the cryptographic operations may be used in more than one of the modes.

In one embodiment, the mode selection signal 201 may be received from an external source, or may be determined based on the content of an input data file or packet from which the input data being processed by the engine 200 is received. In one embodiment, the mode selection signal 201 may be converted by combinatorial logic 203 into a specific set of signals to be used for switching components within the cryptographic engine 200 in order to select the indicated mode.

In one embodiment, the cryptographic engine 200 may perform an AES operation over the received input data by executing a predetermined sequence of cryptographic operations for a number of rounds (loop iterations): 11 rounds for AES-128, 13 rounds for AES-192, and 15 rounds for AES-256. Each AES round produces its result as a function of the intermediate state and a round key corresponding to the round. A key schedule may contain the round keys for the AES operation, and may be generated by the key generator 400 using the key expansion process.

In one embodiment, the key generator 400 may generate different types of keys for each of the different ciphers supported by the cryptographic engine. For example, the key generator 400 may generate keys of a certain size for one cipher and may generate keys of a different size for a different cipher. In addition, the keys may be generated by a different key expansion process for each of the different ciphers, where the different key expansion processes include different sequences of cryptographic operations. For an AES cryptographic engine 200 supporting AES-128, AES-192, and AES-256 ciphers, the key generator may be capable of generating corresponding AES-128, AES-192, and AES-256 keys.

In one embodiment, the key generator 400 may include a set of registers 401-412 or other memory that is used to store the generated keys. In one embodiment, the cryptographic engine 200 may be coupled with the registers 401-412, and may receive the keys from the registers 401-412 as key schedule 202. The cryptographic engine may then generate the output plaintext or ciphertext data using the received key schedule 202. In one embodiment, the cryptographic engine 200 may receive and use the keys as they are generated rather than waiting for the entire key schedule to be completed.

In one embodiment, the mode selection signal 201 may be used to switch the key generator 400 between operation in different modes for generating the different types of keys. For example, the mode selection signal 201 may be used to switch between the AES-128, AES-192, and AES-256 ciphers in which the key generator 400 may be configured to generate AES-128, AES-192, and AES-256 key schedules, respectively. In one embodiment, the mode selection signal 201 may be converted by combinatorial logic 204 into a specific set of signals to be used for switching path selection elements, such as multiplexers or switches, within the key generator 400 in order to select the mode indicated by the mode selection signal 201.

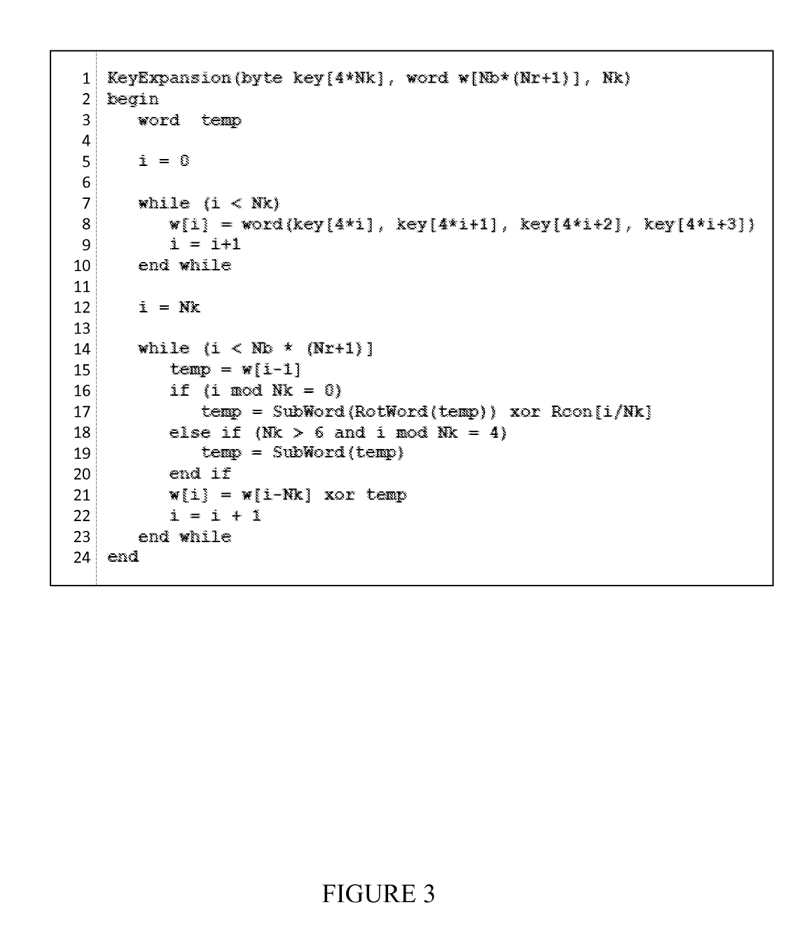

In one embodiment, the key generator 400 may perform a key expansion process that generates one or more new keys based on at least one prior key. For example, the key generator 400 may be an AES key generator that performs a key expansion process as described in Section 5.2 of FIPS, PUB. “197.” Advanced Encryption Standard (AES) 26 (2001). FIG. 3 illustrates pseudocode (lines 1-24) for a function KeyExpansion( ) that performs this key expansion process, according to an embodiment. In the pseudocode listing of FIG. 3, Nk is the number of 32-bit words in the cipher key, Nr is the number of rounds for the key expansion, and Nb is the number of 32-bit words comprising the State, which is an intermediate cipher result generated by the AES cryptographic process. For AES-128, Nk=4 and Nr=10. For AES-192, Nk=6 and Nr=12. For AES-256, Nk=8 and Nr=14.

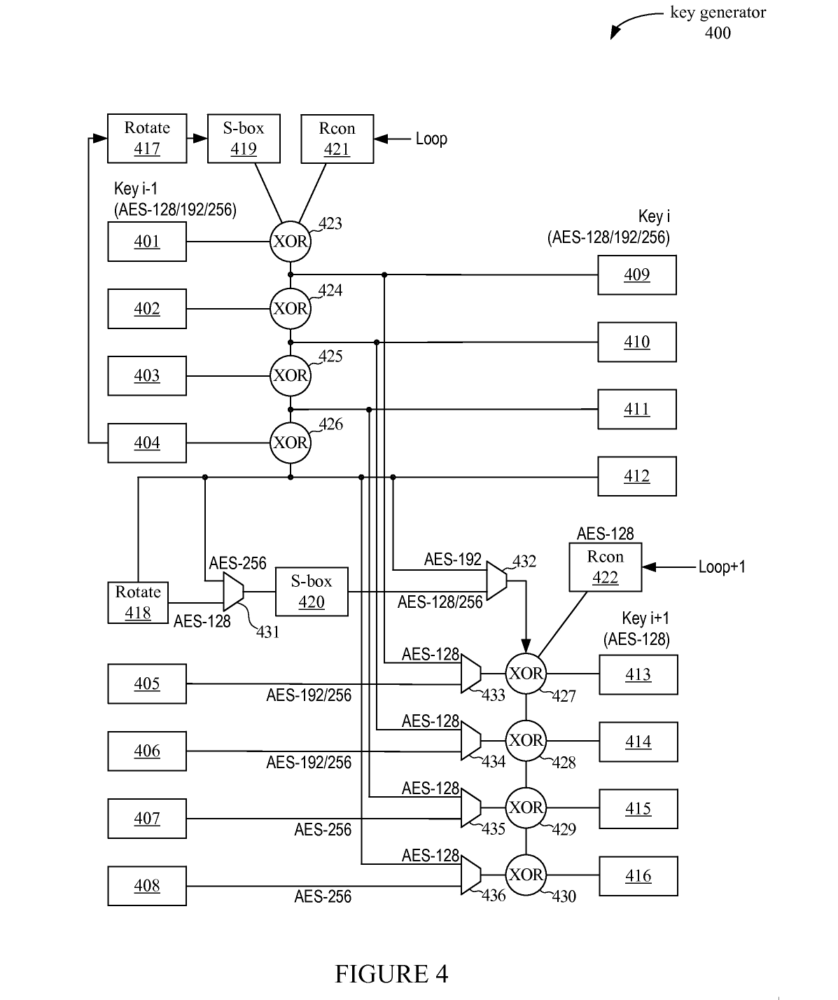

FIG. 4 illustrates an architecture for a key generator 400 that may implement a key expansion process, such as the key expansion process described in the pseudocode in FIG. 3. The key generator 400 includes a first set of word registers 401-408 configured to store a prior key of a key schedule, which may be an already existing key on which the key expansion is based. For example, for each iteration of the key expansion process, one or more new keys may be generated based on the prior key. In one embodiment, each of the word registers 401-408 in the first set of word registers may each be capable of storing at least one word of the prior key.

In one embodiment, the new key or keys that are generated by the key generator 400 are stored in a second set of word registers 409-416. In one embodiment, each of the word registers in the second set of word registers may be capable of storing at least one word of the new key or new keys.

In one embodiment, the word registers 401-408 in the first set of word registers and the word registers 409-416 in the second set of registers may be connected to a set of computational elements 417-430 that are configured to perform various cryptographic operations for generating the new key or keys based on the prior key. Thus, the prior key may be initially stored in the first set of registers 401-408, then one or more new keys may be generated based on the prior key and stored in the word registers 409-416 in the second set of word registers.

In one embodiment, one or more of the computational elements in the set of computational elements may be configured to perform a cryptographic operation such as an XOR operation. For example, each of the computational elements 423-430 performs a bitwise XOR operation between data words received at their respective inputs.

In one embodiment, one or more of the computational elements in the set of computational elements may be configured to perform a cryptographic function that includes a sequence of multiple cryptographic operations. For example, the rotate blocks 417 and 418 may perform a word rotate function as described in FIPS, PUB. “197.” Advanced Encryption Standard (AES) 26 (2001), which may correspond to the RotWord0 function at line 17 of the pseudocode in FIG. 3. Similarly, the S-box blocks 419 and 420 may correspond to the Subword( ) function at lines 17 and 19, and the Rcon blocks 421 and 422 may provide values corresponding to the values provided by the Rcon[ ] array at line 17. In one embodiment, the Rcon blocks 421 and 422 may receive a Loop or Loop+1 signals to select an appropriate value to output from the Rcon blocks 421 and 422, respectively.

In one embodiment, the set of computational elements may include one or more path selection elements, such as multiplexers 431-436 that are each connected to at least one of the other computational elements. For example, the multiplexers 433, 434, 435, and 436 are each connected to XOR blocks 427, 428, 429, and 430, respectively.

In one embodiment, one or more of the path selection elements may be capable of selectively connecting one computational element to another; for example, the multiplexer 433 may be capable of connecting either the word register 405 or the output of XOR block 423 to the XOR block 427. In one embodiment, one or more of the path selection elements may be capable of disconnecting its inputs from its outputs, so that the path selection element does not connect any computational elements to each other.

In one embodiment, one or more of the path selection elements may be used to bypass a computational element; for example, the multiplexer 431 may be used to bypass the rotate block 418 for modes in which the rotate box 418 is not used. In one embodiment, one or more of the path selection elements may be used to bypass another path selection element; for example, the multiplexer 432 may bypass the branch including elements 418 and 420 and multiplexer 431.

In one embodiment, the path selection elements 431-436 may select a computational pathway including a subset of the computational elements for performing a particular sequence of cryptographic operations. In one embodiment, the selected computational pathway may be one of several possible computational pathways that can be selected by the path selection elements 431-436, with each of the possible computational pathways corresponding to one of the available operational modes.

For example, the path selection elements 431-436 may select a first computational pathway including a first subset of the computational elements in response to the mode selection signal 201 indicating a first mode, and may select a second computational pathway including a second subset of the computational elements in response to the mode selection signal 201 indicating a second mode. In one embodiment, the first subset of computational elements may include one or more of the same computational elements in common with the second subset of computational elements.

Similarly, the first and second computational pathways may each include a different subset of registers from the first set of word registers 401-408 used for storing a prior key. In one embodiment, the first computational pathway may include a first subset of the first set of word registers 401-408 while the second computational pathway includes a different second subset of the first set of word registers 401-408. For example, the second computational pathway may include more of the word registers than the first computational pathway. In one embodiment, the first computational pathway may include one or more of the same word registers as the second computational pathway.

In one embodiment, the first and second computational pathways may also each include a different subset of registers from the second set of word registers 409-416 used for storing one or more new keys. In one embodiment, the first computational pathway may include a first subset of the second set of word registers 409-416 while the second computational pathway includes a different second subset of the second set of word registers 409-416. For example, the second computational pathway may include more of the word registers than the first computational pathway. In one embodiment, the first computational pathway may include one or more of the same word registers as the second computational pathway.

In one embodiment, the path selection elements may be capable of selecting more than just two different computational pathways. In one embodiment, the path selection elements may be capable of selecting three or more computational pathways corresponding to three or more key generation modes. For example, the key generator 400 may include path selection elements that can select a first computational pathway for generating an AES-128 key schedule, a second computational pathway for generating an AES-192 key schedule, and a third computational pathway for generating an AES-256 key schedule.

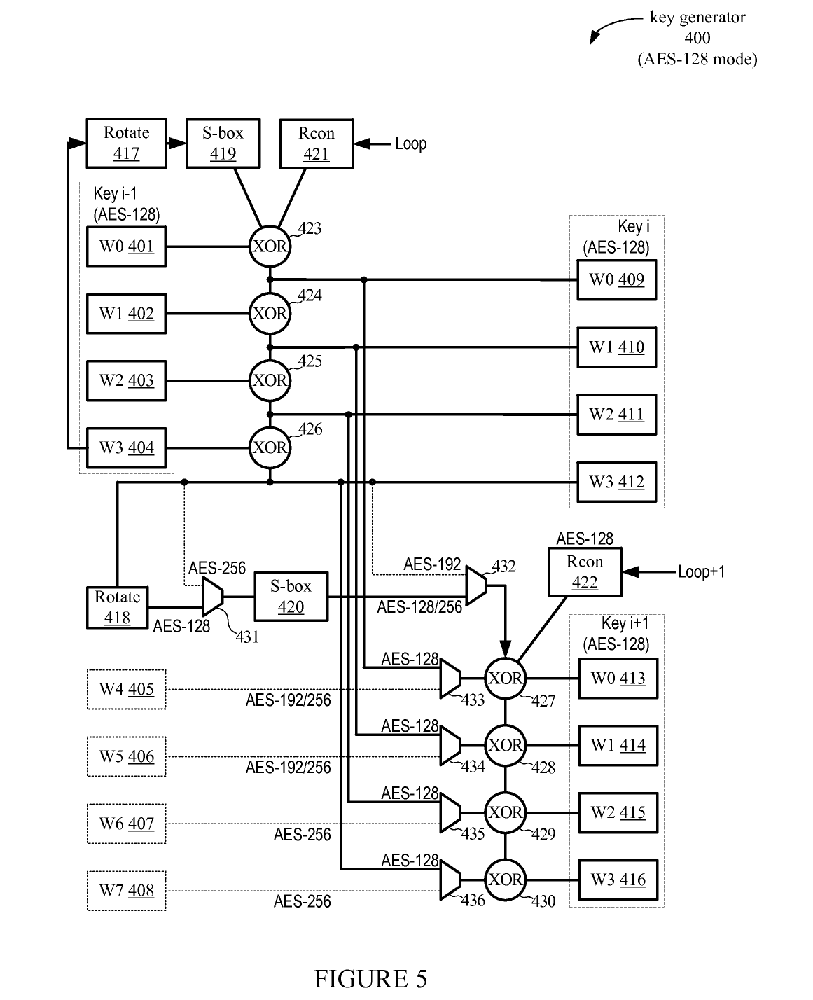

FIG. 5 illustrates a selected computational pathway for generating an AES-128 key schedule, according to one embodiment. In FIG. 5, the selected computational pathway is illustrated with bold lines, while non-selected branches and elements are illustrated with dashed lines. In one embodiment, the computational pathway illustrated in FIG. 5 may be selected by the path selection elements 431-436 in response to a mode selection signal 201 indicating an AES-128 mode. This selected computational pathway includes word registers 401-404 from the first set of word registers, registers 409-416 from the second set of word registers, and computational elements 417-430.

As illustrated in FIG. 5, the computational elements in the selected computational pathway may generate two new AES-128 keys by performing an AES-128 key expansion based on a prior key i−1. The words W0-W3 of the prior key i−1 may be stored in the word registers 401-404. A first new key i may be generated by cryptographic operations performed by blocks 417, 419, 421, and 423-426. The words W0-W3 of this new key i may be stored in word registers 409-412.

In addition to the new key, the selected computational elements may also perform a key expansion process based on the new key i to generate an additional new key i+1. The new key i+1 may be generated by cryptographic operations performed by blocks 418, 420, 422, and 427-430. The words W0-W3 of this key may be stored in word registers 413-416. In one embodiment, the new key i and the additional new key i+1 may be concurrently stored in word registers 409-412 and 413-416, respectively. In one embodiment, the new key i and the additional new key i+1 may be generated during the same clock cycle.

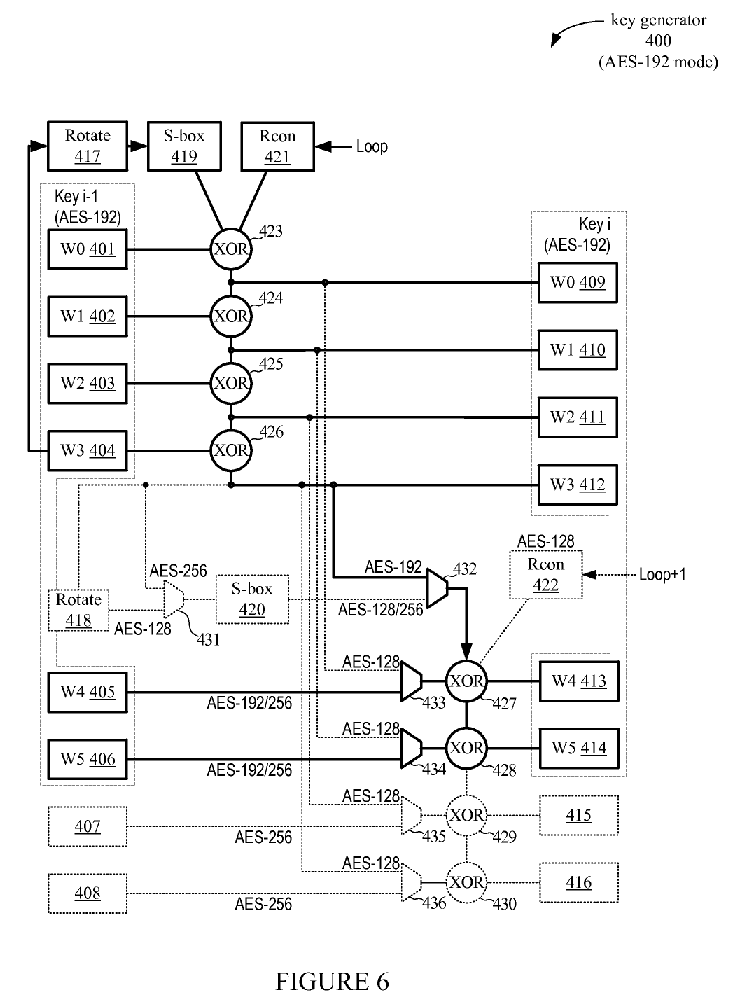

FIG. 6 illustrates a selected computational pathway for generating an AES-192 key schedule, according to one embodiment. In FIG. 6, the selected computational pathway is illustrated with bold lines, while non-selected branches and elements are illustrated with dashed lines. In one embodiment, the computational pathway illustrated in FIG. 6 may be selected by the path selection elements 431-436 in response to a mode selection signal 201 indicating an AES-192 mode. This selected computational pathway includes word registers 401-406 from the first set of word registers, registers 409-414 from the second set of word registers, and computational elements 417, 419, 421, and 423-428.

As illustrated in FIG. 6, the computational elements in the selected computational pathway may generate new AES-192 key by performing an AES-192 key expansion based on a prior key i−1. The words W0-W5 of the prior key i−1 may be stored in the word registers 401-406. A first new key i may be generated by cryptographic operations performed by blocks 417, 419, 421, and 423-428 and the words W0-W5 of this new key i may be stored in word registers 409-414. In one embodiment, two or more of the words of the new key i may be generated in parallel with each other during the same clock cycle.

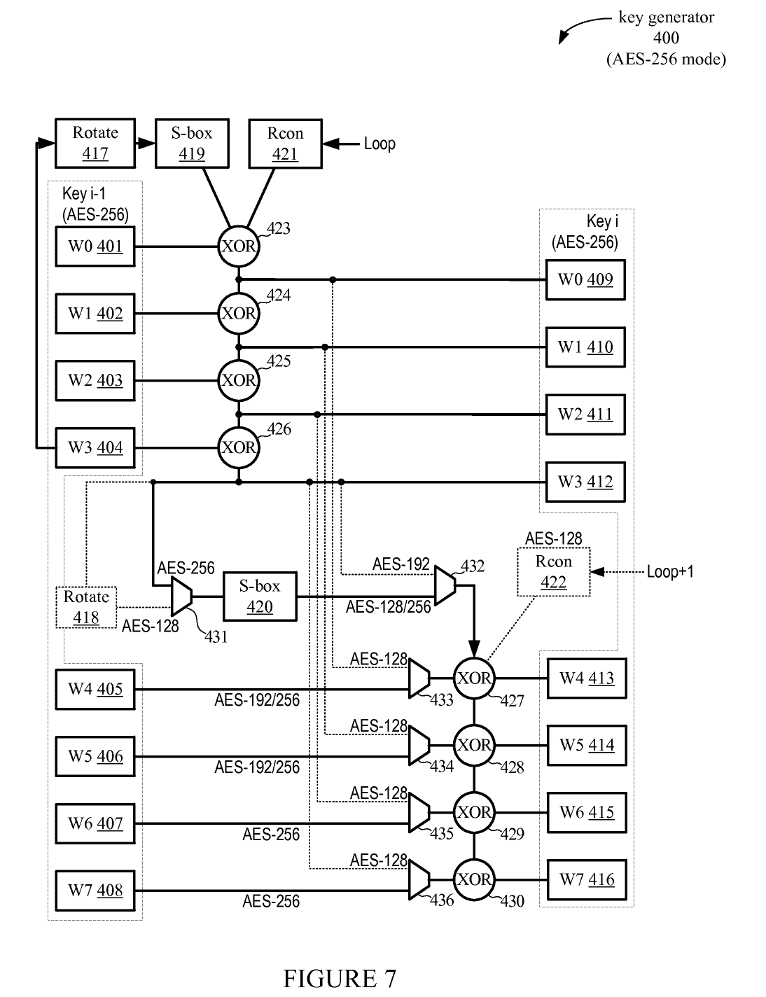

FIG. 7 illustrates a selected computational pathway for generating an AES-256 key schedule, according to one embodiment. In FIG. 7, the selected computational pathway is illustrated with bold lines, while non-selected branches and elements are illustrated with dashed lines. In one embodiment, the computational pathway illustrated in FIG. 7 may be selected by the path selection elements 431-436 in response to a mode selection signal 201 indicating an AES-256 mode. This selected computational pathway includes word registers 401-408 from the first set of word registers, registers 409-416 from the second set of word registers, and computational elements 417, 419-421, 423-430.

As illustrated in FIG. 7, the computational elements in the selected computational pathway may generate new AES-256 key by performing an AES-256 key expansion based on a prior key i−1. The words W0-W7 of the prior key i−1 may be stored in the word registers 401-408. A first new key i may be generated by cryptographic operations performed by blocks 417, 419-421, and 423-430 and the words W0-W7 of this new key i may be stored in word registers 409-416.

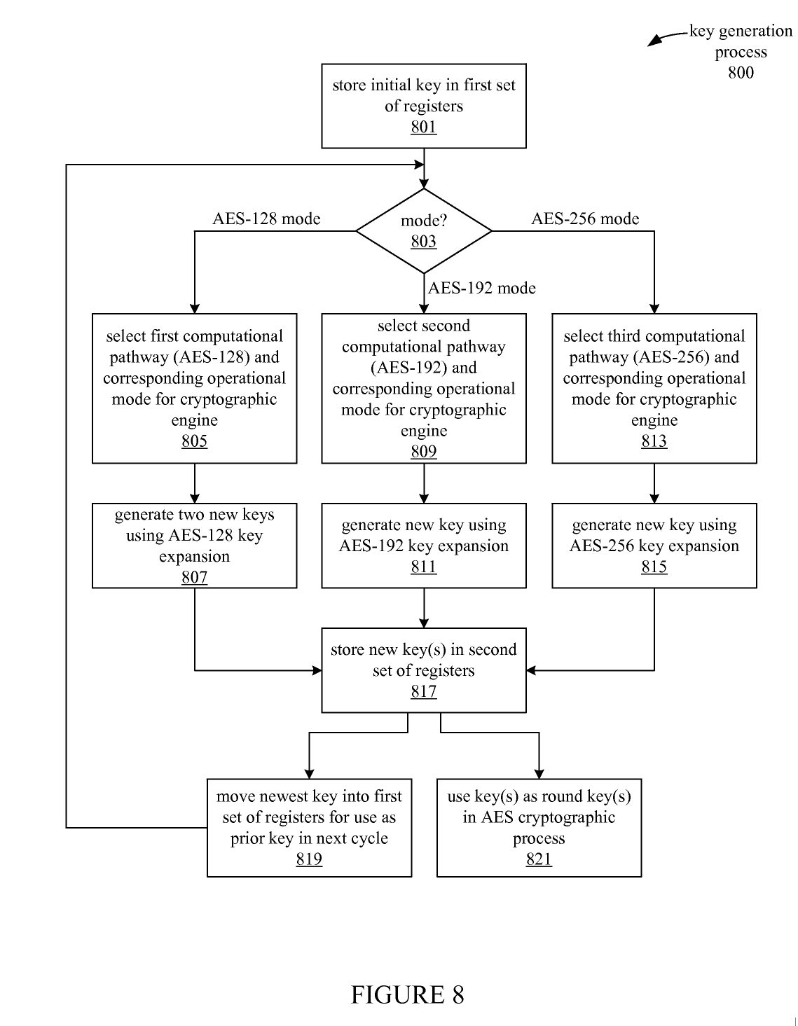

FIG. 8 is a flow diagram illustrating a key generation process 800 for generating a key schedule for use by a cryptographic engine, according to one embodiment. In one embodiment, the key generation process 800 may executed by a key generator such as key generator 400, as illustrated in FIGS. 4-7. In one embodiment, the key generation process 800 is an AES key generation process.

In one embodiment, the key generation process 800 begins at block 801. At block 801, an initial key may be stored in a first set of registers, such as registers 401-408 of key generator 400. In one embodiment, the initial key may be a key that is used for encrypting or decrypting data according to an AES encryption or decryption process. From block 801, the process 800 continues at block 803.

At block 803, the process 800 may continue to one of blocks 805, 809, and 813 in response to a mode selection signal, such as mode selection signal 201 illustrated in FIG. 2. From block 803, if the mode selection signal indicates the AES-128 mode, then the process 800 continues at block 805. If the mode selection signal indicates the AES-192 mode, then the process 800 continues at block 809. If the mode selection signal indicates the AES-256 mode, then the process 800 continues at block 813.

At block 805, the mode selection signal causes the path selection elements 431-436 in the key generator 400 to select a first computational pathway (as illustrated in FIG. 5, for example) including a first subset of computational elements. For the AES-128 mode, the subset of computational elements may include word registers 401-404 from the first set of word registers, registers 409-416 from the second set of word registers, and computational elements 417-430.

In one embodiment, the path selection elements 431-436 may be multiplexers, and selecting the first computational pathway may include switching each of the multiplexers according to the mode selection signal to connect together two or more of the computational elements.

In one embodiment, the mode selection signal may also be used to switch an operational mode of a cryptographic engine to a mode corresponding to the mode of the key generator 400. For example, the mode selection signal may be used to switch an AES engine to perform an AES-128 process when the key generator 400 is switched to the corresponding AES-128 mode. From block 805, the process 800 continues at block 807.

At block 807, the key generator 400 may generate at least one new key by performing an AES-128 key expansion using the computational elements in the selected computational pathway. The computational elements may generate the new key or keys by performing a key expansion process including a sequence of cryptographic operations on the prior key using the selected computational elements. In one embodiment, for an AES-128 mode, the key generator 400 may generate two new keys. For example, the selected computational elements may be used to generate a new key by performing a key expansion based on the prior key, and to generate an additional new key by performing a key expansion based on the new key.

If, at block 803, the mode selection signal indicates the AES-192 mode, then the process 800 continues from block 803 to block 809. At block 809, the mode selection signal causes the path selection elements 431-436 in the key generator 400 to select a second computational pathway (as illustrated in FIG. 6, for example) including a second subset of computational elements. For the AES-192 mode, the subset of computational elements may include word registers 401-406 from the first set of word registers, registers 409-414 from the second set of word registers, and computational elements 417, 419, 421, and 423-428.

In one embodiment, the path selection elements 431-436 may be multiplexers, and selecting the second computational pathway may include switching each of the multiplexers according to the mode selection signal to connect together two or more of the computational elements.

In one embodiment, the mode selection signal may also be used to switch an operational mode of a cryptographic engine to a mode corresponding to the mode of the key generator 400. For example, the mode selection signal may be used to switch an AES engine to perform an AES-192 process when the key generator 400 is switched to the corresponding AES-192 mode. From block 809, the process 800 continues at block 811.

At block 811, the key generator 400 may generate a new key by performing an AES-192 key expansion using the computational elements in the selected computational pathway. The computational elements may generate the new key by performing a key expansion process including a sequence of cryptographic operations on the prior key using the selected computational elements.

If, at block 803, the mode selection signal indicates the AES-256 mode, then the process 800 continues from block 803 to block 813. At block 813, the mode selection signal causes the path selection elements 431-436 in the key generator 400 to select a third computational pathway (as illustrated in FIG. 7, for example) including a third subset of computational elements. For the AES-256 mode, the subset of computational elements may include word registers 401-408 from the first set of word registers, registers 409-416 from the second set of word registers, and computational elements 417, 419-421, 423-430.

In one embodiment, the path selection elements 431-436 may be multiplexers, and selecting the third computational pathway may include switching each of the multiplexers according to the mode selection signal to connect together two or more of the computational elements.

In one embodiment, the mode selection signal may also be used to switch an operational mode of a cryptographic engine to a mode corresponding to the mode of the key generator 400. For example, the mode selection signal may be used to switch an AES engine to perform an AES-256 process when the key generator 400 is switched to the corresponding AES-256 mode. From block 813, the process 800 continues at block 815.

At block 815, the key generator 400 may generate a new key by performing an AES-256 key expansion using the computational elements in the selected computational pathway. The computational elements may generate the new key by performing a key expansion process including a sequence of cryptographic operations on the prior key using the selected computational elements.

From blocks 807, 811, and 815, the process 800 continues at block 817. At block 817, the new key or keys generated at blocks 807, 811, or 815 may be stored in at least some of the registers 409-416. In cases where two keys are generated, the two keys may be stored concurrently in these registers. For example, for the AES-128 mode, the key generator may generate a new key i and an additional new key i+1. The key i may be stored in registers 409-412 while the key i+1 is concurrently stored in registers 413-416. From block 817, the process 800 continues at block 819.

At block 819, the newest key may be moved from the second set of registers 409-416 to the first set of registers 401-408. In the AES-128 mode, for example, the newest key is key i+1 stored in registers 413-416; thus, key i+1 may be moved from registers 413-416 to registers 401-404 to be used as the prior key in the next key expansion cycle. In the AES-192 mode, the newest key is key i stored in registers 409-414, which is moved to registers 401-406. In the AES-256 mode, the newest key is key i stored in registers 409-416, which is moved to registers 401-408. From block 819, the process 800 may continue back to block 803, where the next key expansion cycle continues according to the selected mode with the new prior key stored in the first set of registers.

In one embodiment, the key expansion process 800 may proceed by repeatedly executing the operations of blocks 801-819 to generate the multiple keys in the key schedule. As each new key is generated, the new key may be used in a cryptographic process for encrypting or decrypting data. In one embodiment, the key generator 400 executing the key generation process 800 may provide the generated keys to a cryptographic engine 200. The cryptographic engine may then execute a cryptographic process using the keys. For example, an AES cryptographic engine may use the keys in the key schedule 202 as round keys in an AES encryption or decryption process. In one embodiment, the key schedule 202 includes the prior key and the new key and/or keys that are subsequently generated based on the prior key. In one embodiment, the cryptographic engine 200 may perform a sequence of cryptographic operations corresponding to an operational mode selected by the mode selection signal 201, where the operational mode corresponds to a selected mode of the key generator 400. For example, an AES cryptographic engine may perform a sequence of cryptographic operations for implementing an AES-128 encryption or decryption process when the key generator 400 is operating in the corresponding AES-128 mode.

The embodiments described herein may include various operations. These operations may be performed by hardware components, software, firmware, or a combination thereof. As used herein, the terms “coupled to” or “coupled with” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a non-transitory computer-readable medium. These instructions may be used to program a general-purpose or special-purpose processor to perform the described operations. A computer-readable medium includes any mechanism for storing or transmitting information in a form (e.g., software, processing application) readable by a machine (e.g., a computer). The non-transitory computer-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory, or another type of medium suitable for storing electronic instructions.

Additionally, some embodiments may be practiced in distributed computing environments where the computer-readable medium is stored on and/or executed by more than one computer system. In addition, the information transferred between computer systems may either be pulled or pushed across the transmission medium connecting the computer systems.

Generally, a data structure representing the key generator 400 and/or portions thereof carried on the non-transitory computer-readable medium may be a database or other data structure which can be read by a program and used, directly or indirectly, to fabricate the hardware comprising the key generator 400. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the key generator 400. The netlist may then be placed and routed to produce a data set describing geometric shapes to be applied to masks. The masks may then be used in various semiconductor fabrication steps to produce a semiconductor circuit or circuits corresponding to the key generator 400. Alternatively, the database on the non-transitory computer-readable medium may be the netlist (with or without the synthesis library) or the data set, as desired, or Graphic Data System (GDS) II data.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the embodiments have been described with reference to specific exemplary embodiments thereof. It will, however, be evident that various modifications and changes may be made thereto without departing from the broader spirit and scope of the embodiments as set forth in the appended claims. The specification and drawings are, accordingly, to be regarded in an illustrative sense rather than a restrictive sense.

What is claimed is:

1. An apparatus, comprising:
a first set of word registers each configured to store at least one word of a prior key;
a set of computational elements coupled with the first set of word registers;
one or more path selection elements coupled with the set of computational elements, wherein the one or more path selection elements are configured to select as a selected computational pathway a first computational pathway including a first subset of computational elements from the set of computational elements when a mode selection signal indicates a first mode, and select as the selected computational pathway a second computational pathway including a second subset of computational elements from the set of computational elements when the mode selection signal indicates a second mode different from the first mode; and
a second set of word registers coupled with the set of computational elements, wherein each of the second set of word registers is configured to store at least one word of a new key generated by the selected computational pathway based on the prior key.

2. The apparatus of claim 1, wherein the first subset of computational elements includes one or more of the same computational elements as the second subset of computational elements.

3. The apparatus of claim 1, wherein one or more of the computational elements is configured to perform a cryptographic function including multiple cryptographic operations.

4. The apparatus of claim 1, wherein the first computational pathway includes a first subset of the first set of word registers, and wherein the second computational pathway includes a second subset of the first set of word registers, wherein the number of word registers included in the second subset of the first set of word registers is greater than the number of word registers included in the first subset of the first set of word registers.

5. The apparatus of claim 1, wherein the first subset of computational elements is configured to generate the new key by performing an AES-128 key expansion based on the prior key, wherein the second subset of computational elements is configured to generate the new key by performing an AES-192 key expansion based on the prior key, and wherein a third subset of computational elements from the set of computational elements is configured to generate the new key by performing an AES-256 key expansion based on the prior key.

6. The apparatus of claim 1, wherein the second subset of computational elements is further configured to generate an additional new key by performing a key expansion based on the new key, and wherein the second set of word registers is configured to concurrently store the new key and the additional new key.

7. The apparatus of claim 6, wherein the cryptographic engine is an AES cryptographic engine configured to use each of the prior key and the new key as round keys in an AES cryptographic process for generating the output data.

8. The apparatus of claim 1, further comprising a cryptographic engine coupled with the first set of word registers, wherein the cryptographic engine is configured to generate output data based on a key schedule including the prior key and the new key.

9. A method, comprising:
storing a prior key in a first set of word registers;
in response to a mode selection signal indicating a first mode, selecting as a selected computational pathway a first computational pathway including a first subset of computational elements from a set of computational elements;
in response to the mode selection signal indicating a second mode different from the first mode, selecting as the selected computational pathway a second computational pathway including a second subset of computational elements from the set of computational elements; and
generating a new key by performing a sequence of cryptographic operations based on the prior key using the selected computational pathway.

10. The method of claim 9, further comprising:
generating an additional new key by executing a sequence of cryptographic operations based on the new key; and
concurrently storing the new key and the additional new key in a second set of word registers.

11. The method of claim 9, wherein selecting the selected computational pathway comprises switching each of one or more path selection elements based on the mode selection signal.

12. The method of claim 9, further comprising generating an additional new key concurrently with generating the new key.

13. The method of claim 12, further comprising moving the additional new key into the first set of word registers.

14. The method of claim 9, further comprising performing a sequence of AES cryptographic operations using each of the prior key and the new key as round keys.

15. The method of claim 9, further comprising, in response to the mode selection signal indicating a third mode different from the first mode and different from the second mode, selecting as the selected computational pathway a third computational pathway including a third subset of computational elements from the set of computational elements.

16. The method of claim 15, further comprising:
generating the new key by performing an AES-128 key expansion based on the prior key when the first computational pathway is the selected computational pathway;
generating the new key by performing an AES-192 key expansion based on the prior key when the second computational pathway is the selected computational pathway; and
generating the new key by performing an AES-256 key expansion based on the prior key when the third computational pathway is the selected computational pathway.

17. The method of claim 9, further comprising:
based on the mode selection signal, selecting an operational mode for an AES engine; and
performing a sequence of AES cryptographic operations corresponding to the selected operational mode based on the prior key and the new key.

18. A system comprising:
a cryptographic engine configured to generate output data based on input data and based on a key schedule; and
a key generator coupled with the cryptographic engine, wherein the key generator comprises:
a first set of word registers configured to store a first key of the key schedule;
a set of computational elements coupled with the first set of word registers;
one or more path selection elements configured to select as a selected computational pathway a first computational pathway including a first subset of computational elements from the set of computational elements in response to a mode selection signal indicating a first mode, and configured to select as the selected computational pathway a second computational pathway including a second subset of computational elements from the set of computational elements in response to the mode selection signal indicating a second mode different from the first mode; and
a second set of word registers coupled with the set of computational elements, wherein each of the second set of word registers is configured to store a second key of the key schedule, wherein the second key is generated by the selected computational pathway based on the first key.

19. The system of claim 18, wherein the cryptographic engine is further configured to generate the output data by executing a first set of cryptographic operations when the mode selection signal indicates the first mode, and to generate the output data by executing a second set of cryptographic operations different from the first set of cryptographic operations when the mode selection signal indicates the second mode.

20. The system of claim 18, wherein the cryptographic engine is configured to generate the output data by executing an AES-128 cryptographic process when the mode selection signal indicates the first mode, an AES-192 cryptographic process when the mode selection signal indicates the second mode, and an AES-256 cryptographic process when the mode selection signal indicates a third mode different from the first mode and different from the second mode.
